(19) United States
(12) Patent Application Publication
(10) Pub. No.: US 2015/0109437 A1
(43) Pub. Date: Apr. 23, 2015

(54) METHOD FOR CONTROLLING SURVEILLANCE CAMERA AND SYSTEM THEREOF

(71) Applicant: Amaryllo International, Inc., Zhubei City (TW)

(72) Inventors: Chao-Tung Yang, Zhubei City (TW); Yu-Lin Chen, Zhubei City (TW)

(73) Assignee: Amaryllo International, Inc., Zhubei City (TW)

(21) Appl. No.: 14/139,577

(22) Filed: Dec. 23, 2013

(30) Foreign Application Priority Data
Oct. 18, 2013 (TW) 102137804

(51) Int. Cl. H04N 7/18

(52) U.S. Cl. CPC H04N 7/185
USPC 348/143

(57) ABSTRACT

Disclosed is a method for controlling a surveillance camera, wherein the surveillance camera is remotely controlled by a mobile device, the method comprising: enabling the mobile device to perform an operational motion; and enabling a camera lens of the surveillance camera to perform an operational action corresponding to the operational motion of the mobile device, wherein the operational motion includes: an upward/downward position movement, a leftward/rightward position movement, a forward/backward position movement, a left/right inclining movement, a forward/backward inclining movement, a left/right rotating movement, a shaking movement, a tracking movement, and a combination thereof. By the method of the present invention, a user can more intuitively remotely control a surveillance camera by a mobile device.

### FIELD OF THE INVENTION

The present invention relates to a method for controlling a surveillance camera and a system thereof, and more particularly to a method for remotely controlling a surveillance camera by means of a mobile device and a system thereof.

### BACKGROUND OF THE INVENTION

Typically a user uses a button or a joystick to control an action of a surveillance camera, such as lens turning or photographing. With the popularity of mobile devices such as a smart phone or a table computer, surveillance cameras have been developed which can be controlled by a mobile device, by which the surveillance camera can be controlled not only by a button of a mobile device but also by a touch screen of the mobile device.

However, conventional controlling means such as a button, a joystick or a touch screen are not intuitive enough to a user. Especially, for the elderly or for children, who still seem to have difficulty becoming familiar with the touch screen's operation because the operation is complicated. Therefore, it is necessary to provide a more intuitive method by which a user can conveniently remotely control a surveillance camera by means of a mobile device.

### SUMMARY OF THE INVENTION

Accordingly, the present invention provides a method for controlling a surveillance camera and a system thereof such that a user can more intuitively utilize a mobile device for remotely controlling a surveillance camera.

The present invention provides a method for controlling a surveillance camera, wherein the surveillance camera is remotely controlled by a mobile device, the method comprising: enabling the mobile device to perform an operational motion; and enabling a camera lens of the surveillance camera to perform an operational action corresponding to the operational motion of the mobile device, wherein the operational motion includes: an upward/downward position movement, a leftward/rightward position movement, a forward/backward position movement, a left/right inclining movement, a forward/backward inclining movement, a left/right rotating movement, a shaking movement, a tracking movement, and a combination thereof.

In an embodiment of the present invention, the operational action includes a turning, a rotating, a position movement, a focus adjusting, and/or a photographing for the camera lens.

In an embodiment of the present invention, when the operational motion is the leftward/rightward position movement, the left/right inclining movement, or the left/right rotating movement, then the operational action is a left/right turning for the camera lens.

In an embodiment of the present invention, when the operational motion is the upward/downward position movement or the forward/backward inclining movement, then the operational action is an up/down turning for the camera lens.

In an embodiment of the present invention, when the operational motion is the forward/backward position movement or the forward/backward inclining movement, then the operational action is a focus adjusting for the camera lens.

In an embodiment of the present invention, when the operational motion is the shaking movement, then the operational action is a photographing for the camera lens.

In an embodiment of the present invention, the surveillance camera is remotely controlled by the mobile device through a wireless communication or a wired communication, wherein the wireless communication is a Bluetooth communication, a Wi-Fi communication, a 3G communication, or a 4G communication.

The present invention also provides a system for controlling a surveillance camera, including: a mobile device and a surveillance camera, wherein the surveillance camera is controlled by the mobile device by use of the method of the present invention.

In an embodiment of the present invention, the mobile device includes a motion detecting module that is one or more items selected from a group including a six-axis sensor, an accelerometer and a gyroscope.

In an embodiment of the present invention, the mobile device includes a first communication module, and the surveillance camera includes a second communication module that is remotely communicating with the first communication module.

The method and the system of the present invention have the following advantages. The method of the present invention is a more intuitive operation that directly transforms a user's three-dimensional movement into a control command by which a surveillance camera processes an operational action so as to allow a user to more conveniently control the surveillance camera. Further, the system provided by the present invention can be easily achieved by being directly applied to the current various kinds of mobile devices such as a smart phone or a table computer, or by being applied to a surveillance camera that has a remote controlling function, so that the present invention does not require changing any hardware structure for the mobile device or the surveillance camera. Therefore a user can easily and conveniently control the surveillance camera.

### BRIEF DESCRIPTION OF THE DRAWINGS

FIG. 1 is a flowchart illustrating a method for controlling a surveillance camera according to an embodiment of the present invention;

FIG. 2 to FIG. 10 are control schematic diagrams illustrating a method for controlling a surveillance camera according to different embodiments of the present invention;

FIG. 11 is another flowchart illustrating a method for controlling a surveillance camera according to the embodiment of the present invention; and

FIG. 12 is a system schematic diagram illustrating a system for controlling a surveillance camera according to the embodiment of the present invention.

### DETAILED DESCRIPTION OF THE PREFERRED EMBODIMENTS

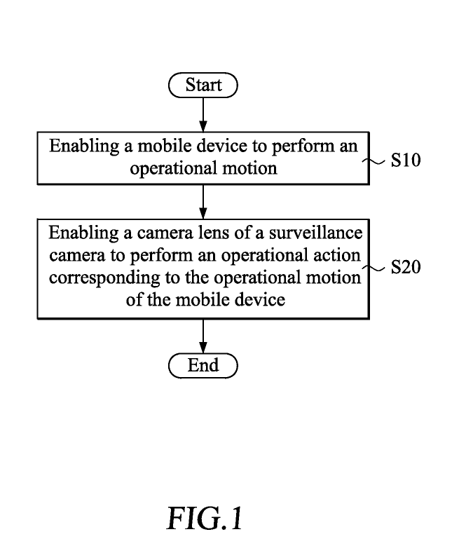

Embodiments of the present invention will be described with reference to FIGS. 1 to 12. The present invention, however, should not be construed as being Limited to the embodiments described herein. These embodiments should be considered as only examples of the present invention.

As referring to FIG. 1 to FIG. 9, a method for controlling a surveillance camera in which a surveillance camera 2 is remotely controlled by a mobile device 1 according to an embodiment of the present invention, includes steps as follows: enabling the mobile device 1 to perform an operational motion (step S10); and enabling a camera lens 20 of the surveillance camera 2 to perform an operational action corresponding to the operational motion of the mobile device 1 (step S20), wherein the operational motion includes: an upward/downward position movement, a leftward/rightward position movement, a forward/backward position movement, a left/right inclining movement, a forward/backward inclining movement, a left/right rotating movement, a shaking movement, a tracking movement, and a combination thereof. Further, the operational action includes operation of a turning, a rotating, a position movement, a focus adjusting, and/or a photographing for the camera lens 20.

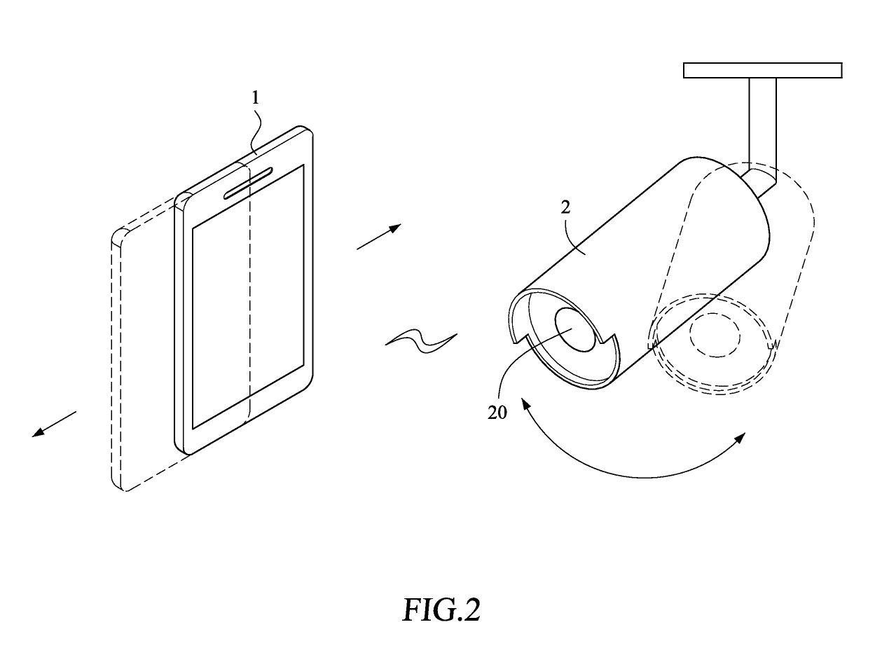

As referring to FIG. 2, the mobile device 1 in an embodiment is a smart phone. Of course, the present invention is not limited to this and the mobile device may be a table computer or a portable smart device. The surveillance camera 2 is remotely controlled by the mobile device 1 through a wireless communication or a wired communication, wherein the wireless communication is a Bluetooth communication, a Wi-Fi communication, a 3G communication, or a 4G communication.

Via the method for controlling a surveillance camera of the present invention, a user can hold the mobile device 1 to perform various operational motions that includes an upward/downward position movement, a leftward/rightward position movement, a forward/backward position movement, a left/right inclining movement, a forward/backward inclining movement, a left/right rotating movement, a shaking movement, a tracking movement, and a combination thereof. Therefore, a user can remotely control the camera lens 20 of the surveillance camera 2 to perform a turning, a rotating, a position movement, a focus adjusting, and/or a photographing. Accordingly, the method for controlling a surveillance camera of the present invention utilizes a more intuitive operational motion than the conventional method, thus making it unnecessary to use a joystick, a button or a touch screen. Several embodiments with respect to an operational motion and its corresponding operational action for the surveillance camera will be described as follows.

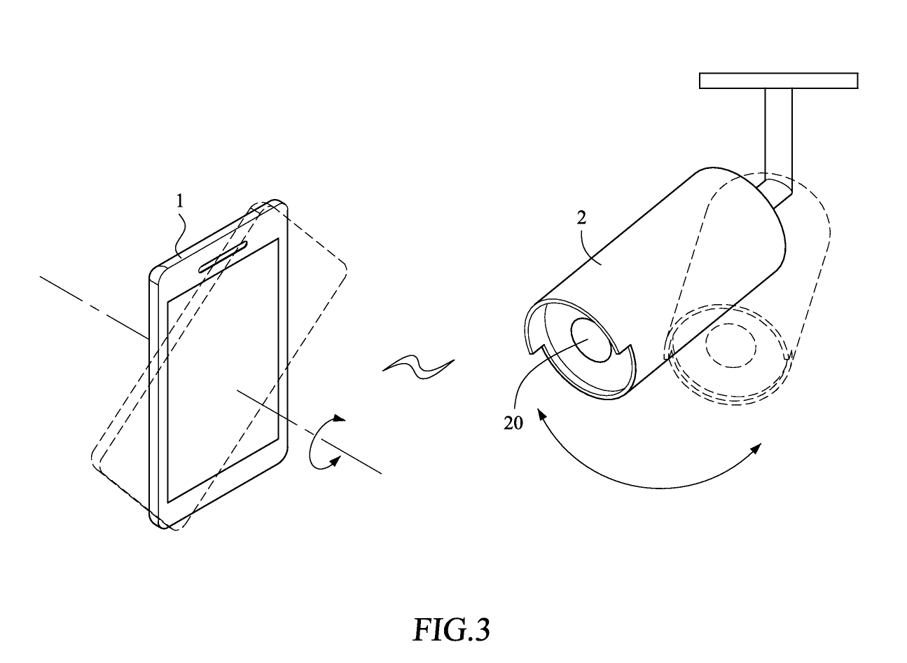

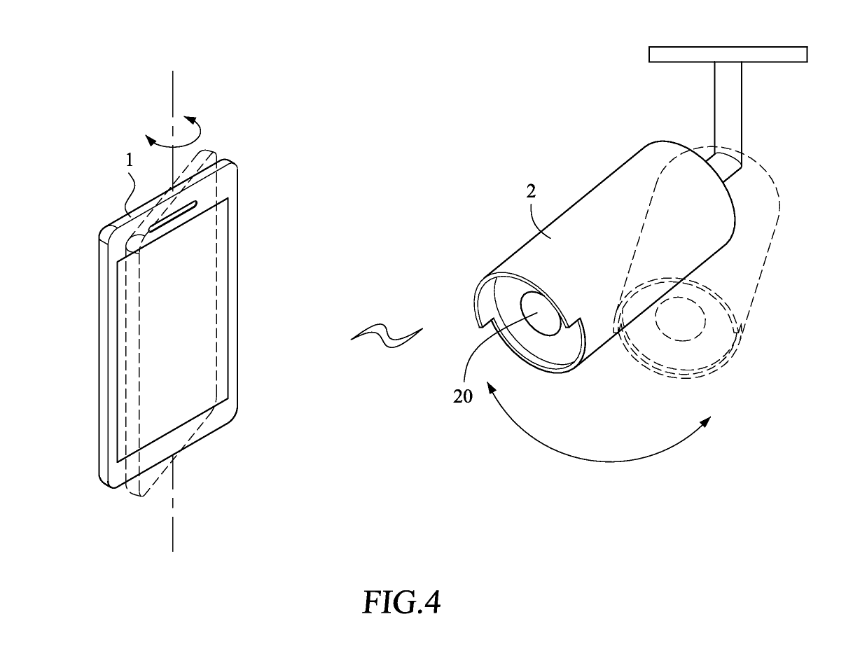

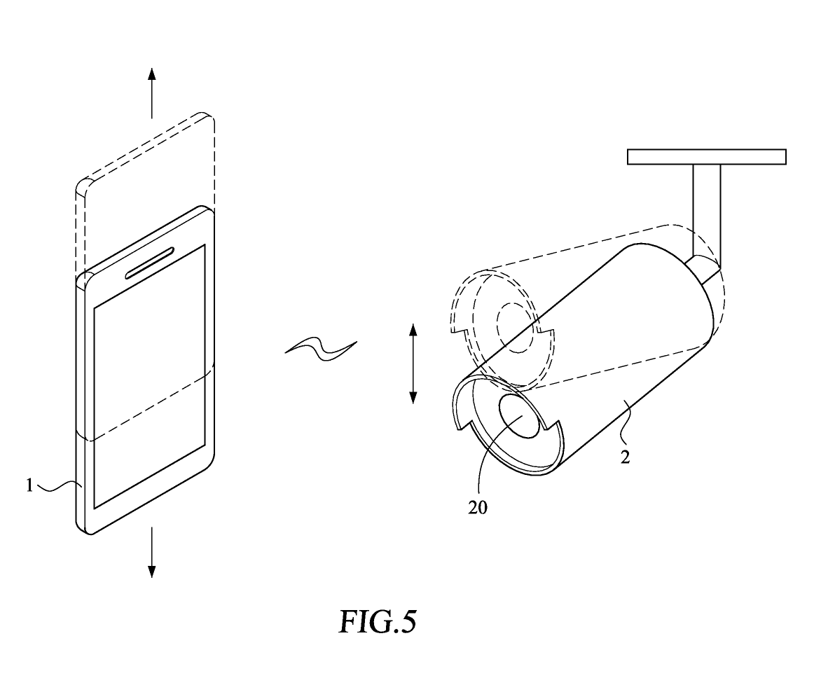

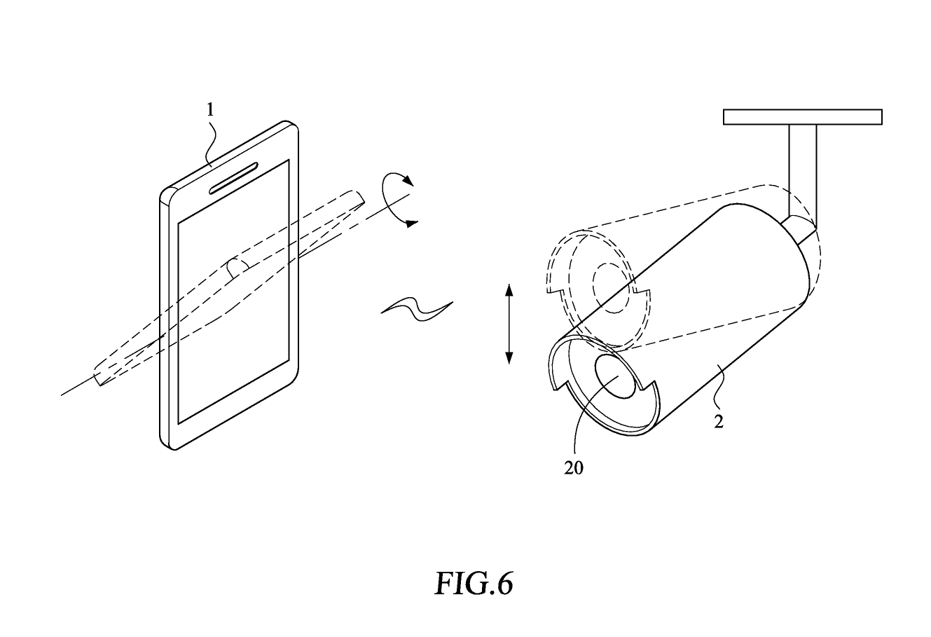

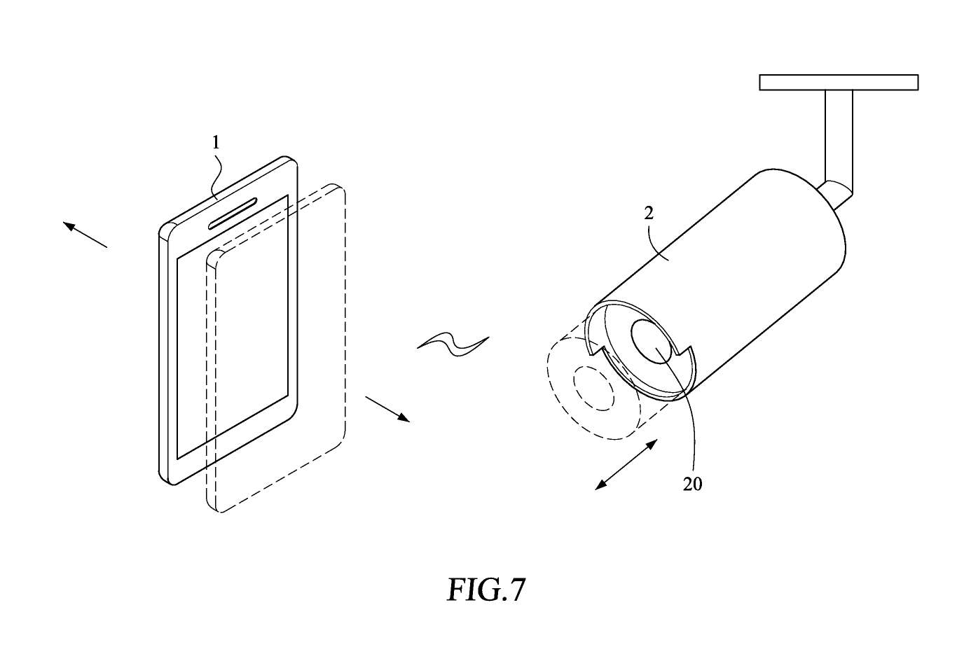

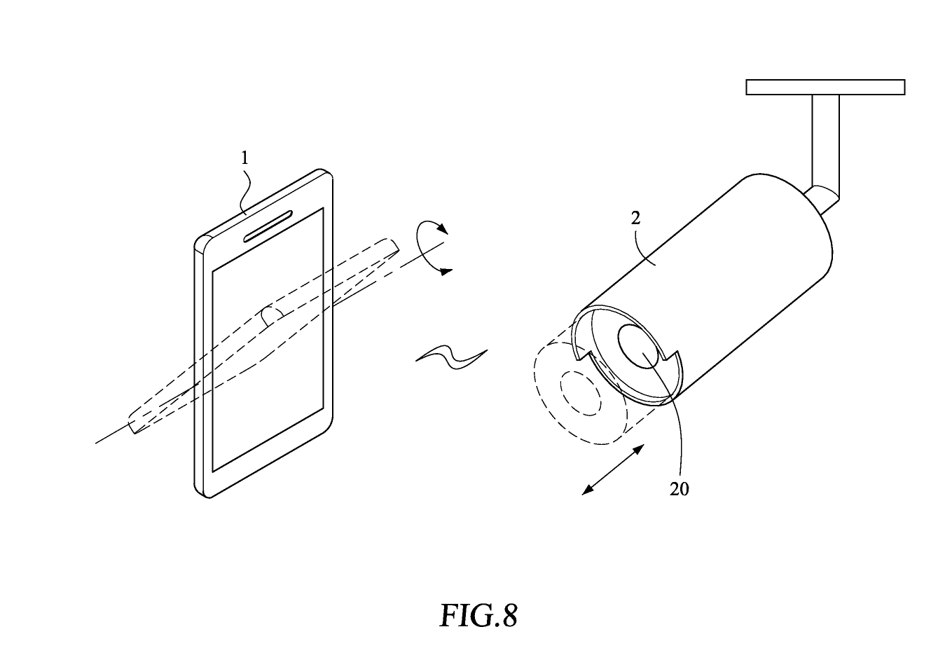

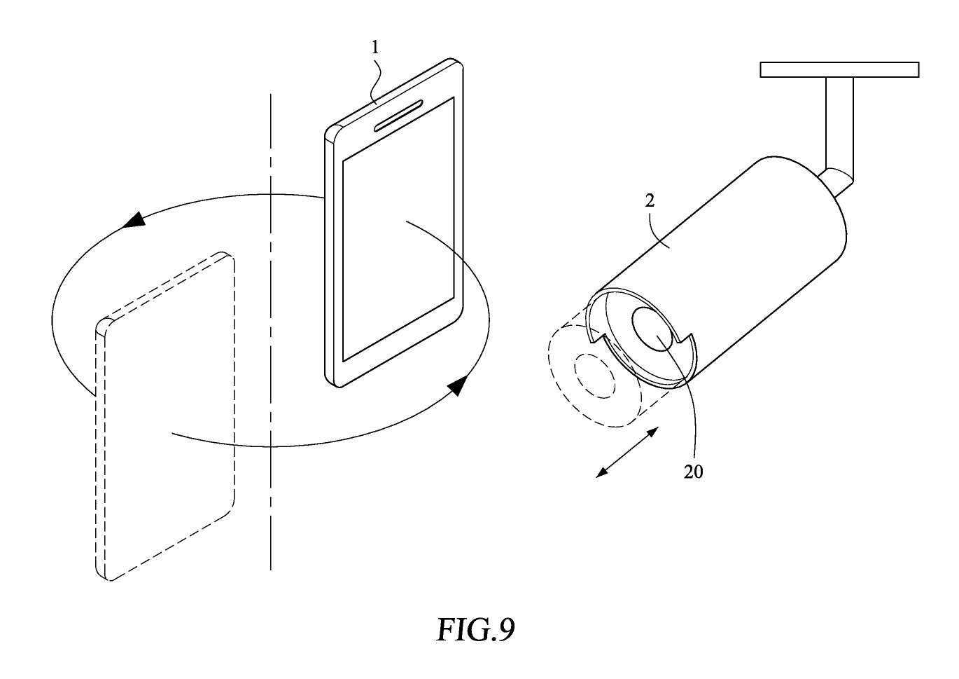

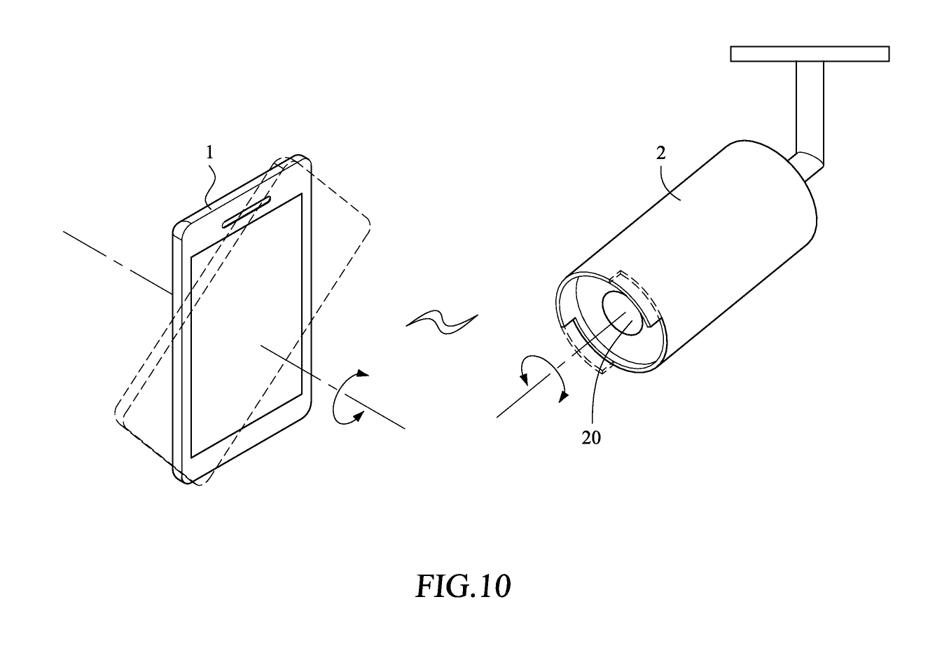

As referring to FIG. 2 to FIG. 4, when the operational motion is a leftward/rightward position movement as shown in FIG. 2, a left/right inclining movement as shown in FIG. 3, or a left/right rotating movement as shown in FIG. 4, then the operational action is a left/right turn for the camera lens 20 in correspondence to the operational motion. As referring to FIG. 5 and FIG. 6, when the operational motion is an upward/downward position movement as shown in FIG. 5, or a forward/backward inclining movement as shown in FIG. 6, then the operational action is an up/down turning for the camera lens 20 in correspondence to the operational motion. As referring to FIG. 7 and FIG. 8, when the operational motion is a forward/backward position movement as shown in FIG. 7, or a forward/backward inclining movement as shown in FIG. 8, then the operational action is a focus adjusting for the camera lens 20 in correspondence to the operational motion. As referring to FIG. 9, when the operational motion is a tracking movement along with a circle path, the operational action is a focus adjusting for the camera lens 20. For example as a detail, a clockwise circle path corresponds to a zoom-in operation for the camera lens 20, and a counterclockwise circle path corresponds to a zoom-out operation for the camera lens 20. As referring to FIG. 10, when the operational motion is a left/right rotating movement, then the operational action is a left/right rotation for the camera lens 20. Further, when the operational motion is the shaking movement, i.e., a quick upward/downward positional movement, a quick leftward/rightward positional movement, and a quick forward/backward positional movement, then the operational action is a photographing for the camera lens 20 in correspondence to the operational motion. Furthermore, when the operational motion is an upward/downward position movement, a leftward/rightward position movement, or a forward/backward position movement, then the operational action is an upward/downward position movement, a leftward/rightward position movement, or a forward/backward position movement for the camera lens 20 (not shown in the figures). However, the present invention is not limited to this. The operational action can be an action of calling a setup menu, a recording status such as a status of the current turning angle, the current rotation angle and a focus length of the camera lens. The operational action can also be an action of starting or stopping recording, or adjusting a recording parameter such as frames per second or an aperture size. Further, a corresponding relationship between the operational motion and the operational action may be defined by a user.

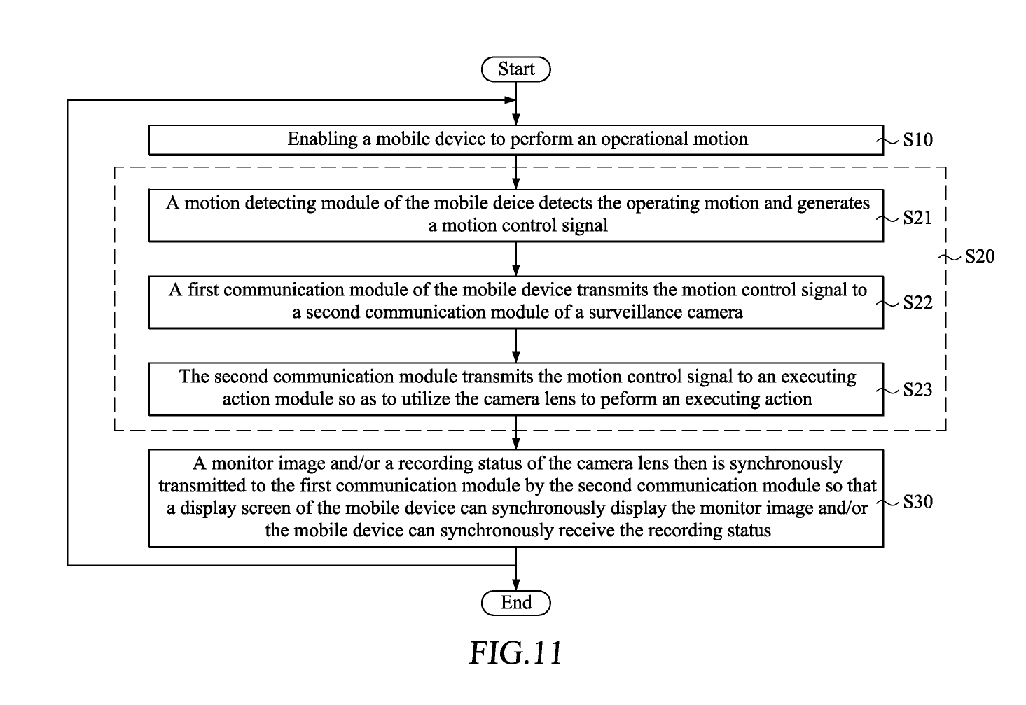

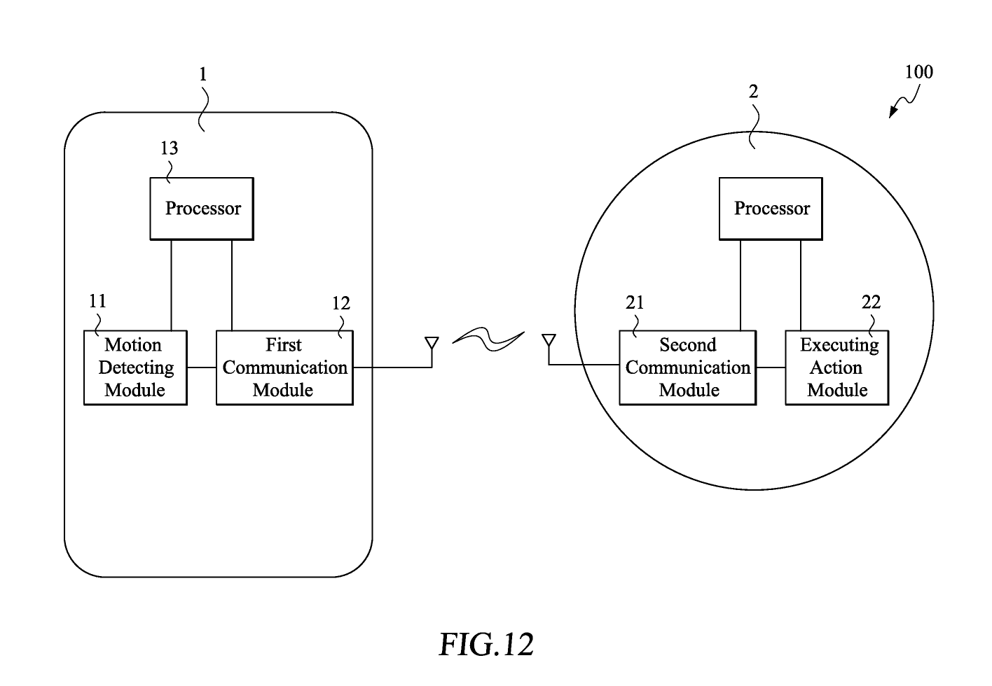

As referring to FIG. 11 and FIG. 12, the step S20 further includes the steps as follows. A motion detecting module 11 of the mobile deice 1 detects the operational motion and generates a motion control signal (step S21). Then a first communication module 12 of the mobile device 1 transmits the motion control signal to a second communication module 21 of the surveillance camera 2 (step S22), and the second communication module 21 transmits the motion control signal to an operational action module 22 so as to utilize the camera lens 20 to perform an operational action (step S23). A monitoring image and/or a recording status of the camera lens 20 then is synchronously transmitted to the first communication module 12 by the second communication module 21 so that a display screen of the mobile device 1 can synchronously display the monitoring image and/or the mobile device can synchronously receive the recording status (step S30), wherein the recording status includes at least one of a turning angle, a rotation angle and a focus of the camera lens 2. After step S30, previous step may be repeated for a continuous control depending on various different situations.

Therefore, as referring to FIG. 3, when a user holds the mobile device to perform a right inclining movement, then the surveillance camera 2 is remotely controlled to turn right, and a monitoring image being turned right is synchronously displayed on the display screen of the mobile device 1. In other words, the display screen of the mobile device 1 provides a real visual effect to a user in a way that a user can immediately see? the monitoring image transmitted from the surveillance camera 2, and thus a user can more intuitively control the surveillance camera 2. Accordingly, the method for controlling a surveillance camera of the present invention is free from touching a joystick or a touch screen, and studying a touch screen gesture is not needed, making the operation simpler as compared with a conventional method.

As referring to FIG. 12, a system for controlling a surveillance camera 100 according to the embodiment of the present invention includes a mobile device 1 and a surveillance camera 2, wherein the mobile device 1 employs the method for controlling a surveillance camera of the present invention to remotely control the surveillance camera 2.

As referring to FIG. 12, the mobile device 1 includes a motion detecting module 11. The motion detecting module 11 includes one or more items selected from a group including a six-axis sensor, an accelerometer, and a gyroscope. The motion detecting module 11 can detect an upward/downward position movement, a leftward/rightward position movement, a forward/backward position movement, a left/right inclining movement, a forward/backward inclining movement, a left/right rotating movement of the mobile device 1. The mobile device 1 has a processor 13 that can analyze that the mobile device 1 is in a shaking movement or is in a particular tracking movement.

As referring to FIG. 12, the mobile device 1 includes a first communication module 12, and the surveillance camera 2 includes a second communication module 21 that is remotely communicating with the second communication module 21.

Further, the system for controlling a surveillance camera 100 according to the embodiments of the present invention can be operated by software. For example, it is popular that a smart phone executes a mobile application, i.e., APP, to utilize a motion detecting module installed in the smart phone to detect an operational motion of the smart phone, and then the smart phone transmits a motion control signal to the surveillance camera to remotely control the surveillance camera. Therefore, the system for controlling a surveillance camera 100 according to the embodiment of the present invention can be easily applied to various mobile devices such as a smart phone or a table computer, or applied to a surveillance camera that has a remote controlling function. However, a hardware change on the mobile device or on the surveillance camera is not needed. Therefore, a user can easily and conveniently control the surveillance camera.

The above description should be considered as only a discussion of the preferred embodiments of the present invention. However, a person skilled in the art may make various modifications to the present invention. Those modifications still fall within the spirit and scope as defined by the appended claims.

What is claimed is:

1. A method for controlling a surveillance camera, wherein the surveillance camera is remotely controlled by a mobile device, the method comprising:
enabling the mobile device to perform an operational motion; and
enabling a camera lens of the surveillance camera to perform an operational action corresponding to the operational motion of the mobile device, wherein the operational motion includes at least one of: an upward/downward position movement, a leftward/rightward position movement, a forward/backward position movement, a left/right inclining movement, a forward/backward inclining movement, a left/right rotating movement, a shaking movement, a tracking movement, and a combination thereof.

2. The method as claimed in claim 1, wherein the operational action includes a turning, a rotating, a position movement, a focus adjusting, and/or a photographing for the camera lens.

3. The method as claimed in claim 1, wherein when the operational motion is the leftward/rightward position movement, the left/right inclining movement, or the left/right rotating movement, then the operational action is a left/right turning for the camera lens.

4. The method as claimed in claim 1, wherein when the operational motion is the upward/downward position movement or the forward/backward inclining movement, then the operational action is an up/down turning for the camera lens.

5. The method as claimed in claim 1, wherein when the operational motion is the forward/backward position movement or the forward/backward inclining movement, then the operational action is a focus adjusting for the camera lens.

6. The method as claimed in claim 1, wherein when the operational motion is the shaking movement, then the operational action is a photographing for the camera lens.

7. The method as claimed in claim 1, wherein the surveillance camera is remotely controlled by the mobile device through a wireless communication or a wired communication, wherein the wireless communication is a Bluetooth communication, a Wi-Fi communication, a 3G communication, or a 4G communication.

8. A system of controlling a surveillance camera, including:
a mobile device and a surveillance camera, wherein the surveillance camera is controlled by the mobile device by use of a method as claimed in claim 1.

9. A system of controlling a surveillance camera, including:
a mobile device and a surveillance camera, wherein the surveillance camera is controlled by the mobile device by use of a method as claimed in claim 2.

10. A system of controlling a surveillance camera, including:
a mobile device and a surveillance camera, wherein the surveillance camera is controlled by the mobile device by use of a method as claimed in claim 3.

11. A system of controlling a surveillance camera, including:
a mobile device and a surveillance camera, wherein the surveillance camera is controlled by the mobile device by use of a method as claimed in claim 4.

12. A system of controlling a surveillance camera, including:
a mobile device and a surveillance camera, wherein the surveillance camera is controlled by the mobile device by use of a method as claimed in claim 5.

13. A system of controlling a surveillance camera, including:
a mobile device and a surveillance camera, wherein the surveillance camera is controlled by the mobile device by use of a method as claimed in claim 6.

14. A system of controlling a surveillance camera, including:
a mobile device and a surveillance camera, wherein the surveillance camera is controlled by the mobile device by use of a method as claimed in claim 7.

15. The system as claimed in claim 8, wherein the mobile device includes a motion detecting module that is one or more items selected from the group consisting of a six-axis sensor, an accelerometer and a gyroscope.

16. The system as claimed in claim 8, wherein the mobile device includes a first communication module, and the surveillance camera includes a second communication module that is remotely communicating with the first communication module.
